(19) United States
(12) Patent Application Publication
(10) Pub. No.: US 2019/0111387 A1
(43) Pub. Date: Apr. 18, 2019

(54) METHOD FOR REDUCING THE WASTE GAS CONCENTRATION OF NOX IN A PLANT FOR PRODUCING NITRIC ACID AS SAID PLANT IS STARTED UP AND/OR SHUT DOWN

(71) Applicants: thyssenkrupp Industrial Solutions AG, Essen (DE); thyssenkrupp AG, Essen (KR)

(72) Inventors: Klaus RUTHARDT, Dortmund (DE); Michael GROVES, Gevelsberg (DE); Paul KERN, Dortmund (DE)

(73) Assignees: thyssenkrupp Industrial Solutions AG, Essen (DE); thyssenkrupp AG, Essen (DE)

(21) Appl. No.: 16/094,268

(22) PCT Filed: Apr. 13, 2017
(86) PCT No.: PCT/EP2017/058943

§ 371 Date: Oct. 17, 2018

(30) Foreign Application Priority Data
Apr. 22, 2016 (DE) 10 2016 206 872.5

(51) Int. Cl. B01D 53/86; C01B 21/40

(52) U.S. Cl. CPC B01D 53/8631; C01B 21/40; B01D 2251/2062; B01D 2257/404; B01D 2252/103; B01D 2257/402; B01D 2259/655

(57) ABSTRACT

A process and a plant for decreasing the concentration of NOx nitrogen oxides in the residual gas in the preparation of nitric acid, where the temperature of the residual gas is regulated by means of a temperature regulating apparatus during shutdown and/or start-up of the plant, with the residual gas being conveyed in a circuit and here flowing through the temperature regulating apparatus and the residual gas purification plant so that colorless shutdown and/or start-up of the plant is made possible.

The present invention relates to a process for decreasing the concentration of NOₓ nitrogen oxides in residual gas which is obtained during shutdown and/or start-up of a plant for preparing nitric acid, where the process comprises the following steps:
(a) regulation of the temperature of the residual gas during shutdown and/or start-up of the plant for preparing nitric acid by means of a temperature regulating apparatus; and
(b) treatment of the residual gas which has been temperature-regulated in step (a) in a residual gas purification plant. The decrease in the concentration of NOₓ nitrogen oxides in the residual gas which is obtained during shutdown and/or start-up of plants for preparing nitric acid makes colorless shutdown and/or start-up of the plant possible.

To prepare nitric acid, ammonia (NH₃) is usually catalytically oxidized by means of atmospheric oxygen. This forms NO which is oxidized by means of oxygen to NO₂ and subsequently absorbed in H₂O in an absorption column to form HNO₃. NO and NO₂ are referred to as nitrous gases or as NOₓ nitrogen oxides. Modern plants for preparing nitric acid are operated under superatmospheric pressure in order to achieve higher acid concentrations and thus improved efficiencies in the absorption and higher degrees of degradation of NOₓ nitrogen oxides in the residual gas.

A distinction is made between dual-pressure and single-pressure plants. In the case of dual-pressure plants, the production of the NOₓ nitrogen oxides by the oxidation of ammonia is carried out at a pressure of from about 4·10⁵ to 6·10⁵ Pa (4 to 6 bar) and the absorption of the resulting NOₓ nitrogen oxides in water to form nitric acid is carried out at from 1·10⁶ to 1.5·10⁶ Pa (10 to 15 bar). In single-pressure plants, on the other hand, the production of the gases and the absorption are carried out at approximately the same pressure, namely from about 6·10⁵ to 1.4·10⁶ Pa (6 to 14 bar). Compressors which are driven by means of a gas and/or steam turbine or an electric motor serve to generate the pressure.

Modern plants for preparing nitric acid are equipped with residual gas purification plants in order to decrease the concentration of the NOₓ nitrogen oxides in the residual gas. The residual gas is subsequently released as offgas into the environment with a decreased concentration of NOₓ nitrogen oxides. The NOₓ nitrogen oxides, i.e. NO and NO₂, are usually reduced in the residual gas purification plants by SCR (Selective Catalytic Reduction) processes with introduction of suitable reducing agents such as ammonia over suitable SCR catalysts such as V₂O_{5/}TiO2-based DeNOx catalysts. The relative proportion of NO₂ based on the total molar amount of NOₓ in the residual gas is characterized by the degree of oxidation of the NOₓ. A further development of the SCR technology in the field of nitric acid technology is the EnviNOx® process in which NOₓ nitrogen oxides are reduced particularly effectively by introduction of suitable reducing agents and NOₓ is in many cases virtually no longer detectable in the offgas. In addition, N₂O is likewise reduced or catalytically decomposed.

The concentrations of the NOₓ nitrogen oxide emissions must, according to official regulations, not exceed a maximum limit value. At present, a value of 50 ppm is a usual limit value, but it is to be expected that this will be reduced in the future.

However, in contrast to steady-state operation of the plants for preparing nitric acid, it is at present not possible, or possible to only a limited extent, to avoid short-term emissions of NOₓ nitrogen oxides which significantly exceed the limit values during shutdown and/or start-up of the plant or in the case of stoppage of the plant.

In the case of stoppage or during shutdown of the plant for preparing nitric acid, the NOₓ nitrogen oxides present under superatmospheric pressure in the plant are usually depressurized into the environment via the absorption column and the residual gas purification plant. However, the residual gas purification plant can be kept in operation only down to a particular permissible limit temperature below which it has to be taken out of operation. Residual gas purification systems in which NH₃ is used as reducing agent for the NOₓ nitrogen oxides can be operated in the long term only above a minimum limit temperature in order to avoid undesirable formation and accumulation of NH₄NO₃ on the SCR catalyst. This limit temperature is frequently in the range from 170 to 200° C. In steady-state operation, plants for preparing nitric acid typically attain operating temperatures of from about 300° C. to about 600° C., at which the residual gas purification plant can be operated without undesirable formation and accumulation of NH₄NO₃.

In general, the switching-off of the residual gas purification plant has to be carried out before complete depressurization of the plant, for which reason the concentration of the NOₓ nitrogen oxides in the residual gas to be released into the environment increases greatly. A further increase in NOₓ nitrogen oxide emissions arises as a result of the absorption column, which is usually equipped with sieve trays, becoming unstable with increasing depressurization of the plant, so that the absorption efficiency decreases greatly. As soon as the residual gas purification plant is no longer in operation, the concentration of NOₓ nitrogen oxide emissions will increase greatly during the remaining depressurization.

In the case of stoppage or shutdown of a plant for preparing nitric acid, the introduction of ammonia for gas production is usually shut off first before the machinery of the plant is switched off. As long as the residual gas purification plant can be kept in operation at above the limit temperatures, the residual gas to be released into the environment will not exceed the concentration of NOₓ nitrogen oxides and the residual gas will be colorless. It is advantageous to keep the machinery in operation as long as possible until the NOₓ nitrogen oxides in the plant for preparing nitric acid have been replaced by air. However, when shutdown of the machinery is necessary immediately after or shortly after shutting off of the introduction of ammonia, such gas replacement is no longer given. Significantly higher emissions of NOₓ nitrogen oxides occur during further depressurization and consequent inevitable reaching of the limit temperature for the residual gas purification plant and the resulting shutdown of the residual gas purification plant.

Owing to the thermodynamic equivalent, the NOₓ nitrogen oxides are present predominately in the form of NO₂ with cooling of the operating temperature, for which reason they become visible as brown gas in the residual gas which is released into the environment.

When starting up the plant, too, the limit value of the concentration of NOₓ nitrogen oxides in the residual gas released into the environment is exceeded. Part of this residual gas is made up of gases which have remained in the pipes and apparatuses or have been formed therein while the plant is down. A further part results from outgassing of NOₓ from unbleached nitric acid (contains dissolved NOₓ) with which the absorption column is usually filled on restarting of the plant.

One method for reducing the concentration of NOₓ nitrogen oxides in residual gases during shutdown and/or start-up of a plant for preparing nitric acid which is operated under superatmospheric pressure, the exiting residual gas of which is treated in a residual gas purification plant, is proposed in DE 102 11 964. Here, the pressure prevailing within the plant is maintained during shutdown of the plant, immediately after stoppage of the residual gas purification plant, and the residual gas is subsequently depressurized in a regulated manner. The residual gas is diluted by means of air fed in from the outside and released into the environment. This measure makes it possible to achieve regulated release of residual gases whose content of NOₓ nitrogen oxides is sufficiently diluted into the environment, so that the concentration of the NOₓ nitrogen oxides is in the range which is not visible. However, the content of NOₓ nitrogen oxides in the residual gas is not decreased by this measure since degradation of the NOₓ nitrogen oxides in the residual gas purification plant is no longer possible.

DE 10 2011 122 142 A1 discloses a process and an apparatus for preparing nitric acid. The process and the apparatus are characterized in that, at least during start-up and/or shutdown of the nitric acid plant, a substream of the medium flowing through the residual gas turbine is taken off in the residual gas turbine and/or in that a substream of the medium fed to the residual gas turbine is taken off upstream of the residual gas turbine and passed to a stack.

DE 10 2012 000 569 A1 discloses a process for the colorless start-up and shutdown of nitric acid plants having the features set forth at the outset. During start-up and/or during shutdown of the nitric acid plant, pressurized heated fluid is fed into the nitric acid plant in order to reduce the speed of the decrease in the temperature of the gas flowing through the nitric acid plant during shutdown of the plant or in order to increase the speed of the increase in the temperature of the gas flowing through the nitric acid plant during start-up of the plant.

DE 10 2012 000 570 A1 discloses a process and an apparatus for preparing nitric acid, characterized in that a residual gas which has been heated by heat exchange with a heated fluid which has flowed through at least one process gas cooler and/or at least one feed water preheater is passed through the residual gas turbine.

DE 10 2012 010 017 A1 discloses a process for decreasing the nitrogen oxide offgas concentration in a nitric acid plant during shutdown and/or start-up and also nitric acid plants suitable for this purpose. The process is characterized in that pressurized offgas containing nitrogen oxides from the nitric acid plant and also gaseous reducing agent for the nitrogen oxides are fed into a reactor which is filled with catalyst and is provided in addition to the reactor of the residual gas purification during start-up and/or during shutdown of the nitric acid plant.

However, the processes and the apparatuses of a plant for preparing nitric acid which is operated under superatmospheric pressure are not satisfactory in every respect during shutdown and/or start-up of the plant and there is a need for improved processes and apparatuses.

It is an object of the invention to decrease the concentration of NOₓ nitrogen oxides in the residual gas which is obtained during shutdown and/or start-up of plants for preparing nitric acid and is released into the environment, with stoppage of the residual gas purification plant being avoided. The concentration of NOₓ nitrogen oxides in the residual gas released into the environment should be below the limit which is visible.

This object is achieved by the subject matter of the claims.

A first aspect of the invention provides a process for decreasing the concentration of NOₓ nitrogen oxides in residual gas which is obtained during shutdown and/or start-up of a plant for preparing nitric acid, where the process comprises the following steps:
(a) regulation of the temperature of the residual gas during shutdown and/or start-up of the plant for preparing nitric acid by means of a temperature regulating apparatus; and
(b) treatment of the residual gas which has been temperature-regulated in step (a) in a residual gas purification plant, wherein the temperature regulating apparatus is a heat exchanger or a heat store and the residual gas is conveyed in a circuit and in this circuit flows through the temperature regulating apparatus and the residual gas purification plant.

The heat exchanger or heat store according to the invention is for the purposes of the invention not restricted in terms of its structure. Suitable heat exchangers encompass shell-and-tube heat exchangers, plate heat exchangers, helical heat exchangers, U-tube heat exchangers, casing-tube heat exchangers, etc. Suitable heat stores in principle encompass all components which have a comparatively large heat capacity and can take up heat from gases and release this heat again to gases. Suitable heat exchangers and heat stores are known to a person skilled in the art.

The process for decreasing the concentration of NOₓ nitrogen oxides in the residual gas is preferably carried out in a plant for preparing nitric acid which is operated under superatmospheric pressure. Compressors which are driven by means of a gas and/or steam turbine or an electric motor preferably serve for generating the pressure. A gas turbine is preferably operated using the offgas from the plant for preparing nitric acid with utilization of the pressure applied by at least one compressor.

A person skilled in the art can distinguish the state of a plant for preparing nitric acid during shutdown and/or start-up thereof from the state of the plant during steady-state operation thereof. The shutdown of the plant follows steady-state operation, while start-up of the plant precedes steady-state operation.

In step (a) of the process of the invention the temperature of the residual gas is regulated by means of a temperature regulating apparatus during the shutdown and/or start-up of the plant for preparing nitric acid. A person skilled in the art will understand regulation of the temperature to mean setting of the temperature, in the process of the invention the setting of the temperature of the residual gas. Here, energy is transferred to the residual gas, preferably in the form of heat.

In a preferred embodiment, the regulation of the temperature is carried out over the entire duration of the shutdown and/or start-up of the plant for preparing nitric acid, but can also occur for only part of the time. The regulation of the temperature of the residual gas can also, but does not have to, be carried out during steady-state operation, which encompasses the part load, full load and overload case. In a preferred embodiment, the process of the invention can be carried out both in steady-state operation and also in part load operation of the plant for preparing nitric acid. Part load operation of the plant for preparing nitric acid refers to the state of the plant in which it is continually operated below its maximum possible capacity.

For example, the regulation of the temperature of the residual gas can be carried out at or shortly before the point in time at which the temperature of the residual gas during shutdown of the plant for preparing nitric acid reaches the lower limit value of the operating temperature of the residual gas purification plant and/or as long as the temperature of the residual gas during start-up of the plant for preparing nitric acid has not yet reached the lower limit value of the operating temperature of the residual gas purification plant. The commencement of shutdown of the plant for preparing nitric acid and the commencement of the regulation of the temperature by means of the temperature regulating apparatus do not have to coincide in time.

The period of shutdown and/or start-up of the plant can, but does not have to, be characterized by a decrease or an increase in the pressure within the plant for preparing nitric acid. For example, the temperature of the residual gas is regulated by means of the residual gas purification plant during shutdown of the plant for preparing nitric acid until ambient pressure prevails within the plant for preparing nitric acid.

In another preferred embodiment, the temperature of the residual gas is also regulated by means of the temperature regulating apparatus after reaching and/or before leaving ambient pressure, i.e. in the depressurized state of the plant for preparing nitric acid.

The regulation of the temperature of the residual gas is preferably carried out as a function of the temperature thereof. In another preferred embodiment, the temperature of the residual gas is regulated as soon as the introduction of ammonia for producing the NOₓ nitrogen oxides is shut off during shutdown of the plant or is opened during start-up of the plant.

The temperature of the residual gas is preferably regulated so that very long operation of the residual gas purification plant after shutdown or very early operation of the residual gas purification plant during start-up of the plant for preparing nitric acid is made possible.

The residual gas is preferably brought to a temperature in the range from 300 to 550° C. in step (a).

The residual gas is preferably brought to a temperature in the range from 200° C. to 550° C., more preferably in the range from 300° C. to 480° C. and most preferably in the range from 260° C. to 380° C., in step (a).

The residual gas is preferably brought to at least 300° C., more preferably at least 325° C., even more preferably at least 350° C., most preferably at least 375° C. and in particular at least 400° C., in step (a).

The residual gas is preferably brought to not more than 550° C., preferably not more than 525° C., even more preferably not more than 500° C., most preferably not more than 475° C. and in particular not more than 450° C., in step (a).

Various means can be used for regulating the temperature of the residual gas. Preference is given to using heat exchangers and/or heat stores for regulating the temperature of the residual gas.

In a preferred embodiment, the temperature regulating apparatus is electrically operated and/or the temperature regulating apparatus comprises a burner.

If the temperature regulating apparatus is electrically operated, it can, for example, be equipped with electrically operated heating elements. Corresponding means for operating an electric temperature regulating apparatus are known to a person skilled in the art.

If the temperature regulating apparatus comprises a burner, a fuel is preferably reacted in the burner so as to produce heat by means of which the temperature of the residual gas can be regulated.

In a preferred embodiment, conduits through which the residual gas flows are heated by means of the burner. In this way, the temperature of at least parts of the residual gas can be regulated.

In another preferred embodiment, at least part of the residual gas is mixed with at least part of the offgases from the burner, by which means the temperature of the residual gas can be regulated. If the residual oxygen concentration in the residual gas is sufficiently high, it is likewise possible for at least part of the residual gas to be mixed with a fuel and reacted in the burner. The heated offgas formed in this way can subsequently, or even during the reaction in the burner, be mixed with the residual gas. In this way, the temperature of the residual gas can be regulated.

In step (b) of the process of the invention, the residual gas which has been temperature-regulated in step (a) is treated in a residual gas purification plant.

The residual gas is preferably treated in the residual gas purification plant in order to decrease the concentration of NOₓ nitrogen oxides in the residual gas. Residual gas purification plants are known to a person skilled in the art and usually make reduction of the NOₓ nitrogen oxides NO and NO₂ by means of SCR processes with introduction of suitable reducing agents possible. In addition, they preferably make catalytic reduction or decomposition of N₂O possible.

The residual gas purification plant is preferably equipped with catalysts for degradation of NOₓ nitrogen oxides (DeNOₓ catalysts). These catalysts are known to a person skilled in the art. In general, they are transition metal catalysts which promote the chemical reaction of NOₓ nitrogen oxides with reducing agents. Preference is given to classical DeNOₓ catalysts, in particular those containing transition metals and/or transition metal oxides, e.g. iron, nickel, copper, cobalt, manganese, rhodium, rhenium or vanadium oxides or metallic platinum, gold or palladium or else mixtures of two or more of these compounds. Particular preference is given to catalysts based on V₂O₅-TiO₂.

Catalysts used according to the invention usually contain further additives known to a person skilled in the art, e.g. binders, for example aluminosilicates or boehmite.

The catalyst can be present as shaped bodies of any size and geometry, preferably with geometries which have a relatively large ratio of surface area to volume and in the case of which flow through them produces a very small pressure drop.

Apart from the DeNOₓ catalysts which catalyze the chemical reaction of the NOₓ nitrogen oxides with reducing agents, the residual gas purification plant can also contain catalysts which promote the chemical decomposition of N₂O into nitrogen and oxygen and the chemical reduction of N₂O by reducing agents. These catalysts are known to a person skilled in the art.

In addition to the residual gas which contains NOₓ nitrogen oxides, reducing agents for nitrogen oxides, in particular reducing agents for NOₓ, are also introduced into the residual gas purification plant. Suitable reducing agents for NOₓ nitrogen oxides are any material which is known to a person skilled in the art and has a high activity for reduction of NOₓ. These can be, for example, nitrogen-containing reducing agents. As nitrogen-containing reducing agents, it is possible to employ any compounds which are suitable for the reduction of NOₓ. Examples are azanes, hydroxyl derivatives of azanes and also amines, oximes, carbamates, urea or urea derivatives. Urea and urea derivatives are preferably used in the form of aqueous solutions.

Particular preference is given to using ammonia as reducing agent for nitrogen oxides, in particular for NOₓ nitrogen oxides.

In addition to the reducing agent for NOR, a reducing agent for N₂O can be introduced into the residual gas to be treated. This can be a nitrogen-containing reducing agent. Examples have been given further above. However, gaseous hydrocarbons, carbon monoxide or hydrogen are also possible here. Particular preference is given to using ammonia as reducing agent for N₂O.

The regulation of the temperature of the residual gas is preferably utilized for decreasing the concentration of NOₓ in the residual gas in the residual gas purification plant, preferably during shutdown and/or start-up of the plant for preparing nitric acid. The regulation of the temperature preferably serves to heat the residual gas to a temperature or to prevent or delay cooling of the residual gas below a temperature which is at least necessary for chemical reactions which take place in the residual gas purification plant for reducing the concentration of NOₓ nitrogen oxides and which are preferably catalyzed to be able to proceed.

In a preferred embodiment, the concentration of NOₓ nitrogen oxides in the residual gas during shutdown and/or start-up of the plant for preparing nitric acid is decreased by at least 10%, preferably by at least 20%, at least 30%, at least 40%, at least 50%, at least 60%, at least 70%, at least 80%, at least 90% or at least 99%.

In a further preferred embodiment, the concentration of N₂O in the residual gas is reduced by at least 10%, more preferably by at least 20%, at least 30%, at least 40%, at least 50%, at least 60%, at least 70%, at least 80%, at least 90% or at least 99%.

The required amounts of reducing agent are dependent on the type of reducing agent and can be determined by a person skilled in the art by means of routine experiments.

The temperature of the residual gas can be regulated at various places in the process of the invention; the temperature of the residual gas is preferably regulated before and/or after flow through the residual gas purification plant.

Here, the residual gas is conveyed at least partly or in its entirety in a circuit and here flows through the temperature regulating apparatus and the residual gas purification plant, preferably additionally also firstly through the plant for preparing nitric acid.

If the temperature of the residual gas is regulated at a point in time only after the residual gas first flows through the residual gas purification plant, the residual gas is preferably conveyed in a circuit.

The residual gas being conveyed in the circuit preferably flows through the temperature regulating apparatus and the residual gas purification plant. In another preferred embodiment, the residual gas is returned at a suitable place into the plant for preparing nitric acid. The residual gas being conveyed in the circuit is preferably introduced into the pipe which in steady-state operation conveys the NOₓ nitrogen oxides produced in the burner to the absorption column.

The residual gas conveyed in the circuit preferably flows through the temperature regulating apparatus, the residual gas purification plant and the absorption column. Temperature regulating apparatus, residual gas purification plant and absorption column can be arranged at any place in the circuit. The residual gas conveyed in the circuit preferably flows firstly through the temperature regulating apparatus, subsequently through the absorption column and then through the residual gas purification plant before it is fed back into the circuit.

If the temperature of the residual gas is regulated at a point in time after the residual gas first flows through the residual gas purification plant, the residual gas has preferably not been temperature-regulated when it first flows through the residual gas purification plant. Only after the first circuit cycle has been completely passed through and the second passage through the residual gas purification plant has occurred is the temperature of the residual gas preferably regulated for treatment in the residual gas purification plant. In this case, the step (a) according to the invention preferably follows step (b) in time.

Accordingly, steps (a) and (b) can be carried out in alphabetic order, but do not have to be.

If the temperature of the residual gas is regulated at a point in time only after the first passage of the residual gas through the residual gas purification plant, preference is given to at least 10% by volume of the residual gas being conveyed in the circuit, more preferably at least 20% by volume, at least 30% by volume, at least 40% by volume, at least 50% by volume, at least 60% by volume, at least 70% by volume, at least 80% by volume, at least 90% by volume, at least 99% by volume. The residual gas is preferably conveyed in the circuit in its entirety.

The residual gas is preferably released into the environment only when a concentration of NOₓ nitrogen oxides which is not visible has been reached in the residual gas. The concentration of NOₓ nitrogen oxides in the residual gas released into the environment (offgas) is preferably not more than 100 ppm, more preferably not more than 90 ppm, not more than 80 ppm, not more than 70 ppm, not more than 60 ppm, not more than 50 ppm, not more than 40 ppm, not more than 30 ppm, not more than 20 ppm or not more than 10 ppm.

In the circuit, the residual gas is preferably conveyed via a compressor or a blower, preferably in order to maintain the circuit.

In a preferred embodiment, the residual gas flows through the temperature regulating apparatus only during shutdown and/or start-up of the plant for preparing nitric acid but not during steady-state operation of the plant for preparing nitric acid.

If the temperature regulating apparatus is a heat exchanger which is located downstream of the residual gas purification plant, the residual gas preferably flows through this heat store only during shutdown and/or start-up of the plant for preparing nitric acid but not during steady-state operation of the plant for preparing nitric acid.

In a preferred embodiment, the residual gas flows through the temperature regulating apparatus both during steady-state operation of the plant for preparing nitric acid and during shutdown and/or start-up of the plant for preparing nitric acid.

If the temperature regulating apparatus is a heat exchanger which is located upstream of the residual gas purification plant, or a heat store, the residual gas preferably flows through the heat exchanger or the heat store both during steady-state operation and during shutdown and/or start-up of the plant for preparing nitric acid.

If the temperature of the residual gas is regulated at a point in time before the residual gas flows through the residual gas purification plant, the steps (a) and (b) according to the invention are carried out sequentially in time.

The temperature regulating apparatus is, preferably at least during shutdown and/or start-up of the plant for preparing nitric acid, preferably supplied with a medium which is suitable for releasing heat.

In another preferred embodiment, the temperature regulating apparatus is suitable for taking up heat from a medium, storing it and releasing it again when required.

The medium is preferably discharged from the plant for preparing nitric acid and/or supplied from external sources.

The medium preferably comprises high-pressure steam.

A further aspect of the invention provides an apparatus for decreasing the concentration of NOₓ nitrogen oxides in residual gas which is obtained during shutdown and/or start-up of a plant for preparing nitric acid, comprising the following components which are functionally connected to the plant for preparing nitric acid:
(A) a temperature regulating apparatus which is configured for regulating the temperature of the residual gas during shutdown and/or start-up of the plant for preparing nitric acid; and
(B) a residual gas purification plant which is configured for decreasing the concentration of NOₓ nitrogen oxides in the residual gas whose temperature has been regulated by means of the temperature regulating apparatus;
(C) a gas bypass apparatus which is arranged downstream of the residual gas purification plant and is configured for diverting the residual gas into the temperature regulating apparatus; and
(D) a conduit which is arranged downstream of the temperature regulating apparatus and is configured for returning the residual gas into a circuit with passage through the temperature regulating apparatus and the residual gas purification plant.

The temperature regulating apparatus in the apparatus of the invention is preferably a heat exchanger or a heat store.

The apparatus of the invention preferably comprises the following additional components which are functionally connected to the plant for preparing nitric acid:
(E) a measuring apparatus which is configured for determining the concentration of NOₓ nitrogen oxides in the residual gas; and/or
(F) a compressor and/or a blower.

The residual gas which is conveyed via the conduit (D) is preferably at least partly returned into a circuit.

Preference is given to at least 10% by volume of the residual gas being returned via conduit (D) into a circuit, more preferably at least 20% by volume, at least 30% by volume, at least 40% by volume, at least 50% by volume, at least 60% by volume, at least 70% by volume, at least 80% by volume, at least 90% by volume, at least 99% by volume. Preference is given to residual gas being returned in its entirety via conduit (D) into a circuit.

The residual gas which is conveyed via the conduit (D) with passage through parts of the plant for preparing nitric acid, the temperature regulating apparatus and the residual gas purification plant is preferably returned to a circuit. The residual gas which is conveyed via the conduit (D) is preferably fed into the conduit which in steady-state operation conveys the NOₓ nitrogen oxides from the burner to the absorption column and preferably likewise flows through the absorption column, the temperature regulating apparatus and the residual gas purification plant.

The compressor or the blower (F) are preferably arranged downstream of the residual gas purification plant and configured for blowing out the residual gases through a stack.

In another preferred embodiment, the residual gas is conveyed in the circuit by the compressor or the blower (F) in order to maintain the circuit.

In a preferred embodiment, the temperature regulating apparatus of the apparatus of the invention is
(i) a heat exchanger which can be supplied with a medium which is suitable for releasing or taking up heat;

or
(ii) a heat store which is configured for storing heat from the residual gas during steady-state operation of the plant for preparing nitric acid and which is configured for releasing heat to the residual gas during shutdown and/or start-up of the plant for preparing nitric acid.

The temperature regulating apparatus of the apparatus of the invention is preferably a heat exchanger which is arranged upstream of the residual gas purification plant and can be supplied with a medium which is suitable for releasing or taking up heat.

In another preferred embodiment, the temperature regulating apparatus of the apparatus of the invention is a heat store which is arranged upstream or downstream of the residual gas purification plant and is configured for storing heat from the residual gas during steady-state operation of the plant for preparing nitric acid, and which is configured for releasing heat to the residual gas during shutdown and/or start-up of the plant for preparing nitric acid.

The apparatus of the invention is preferably used according to the process of the invention.

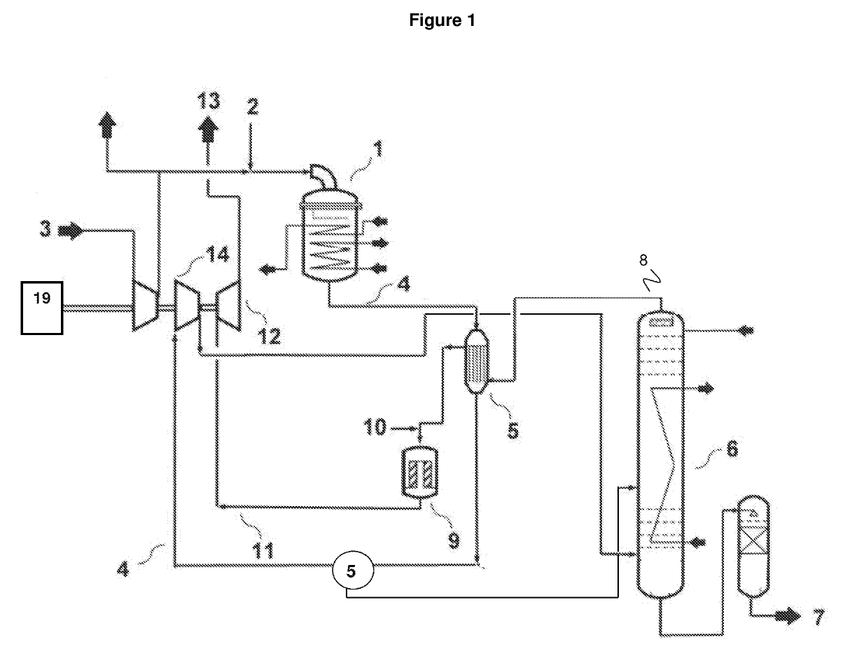

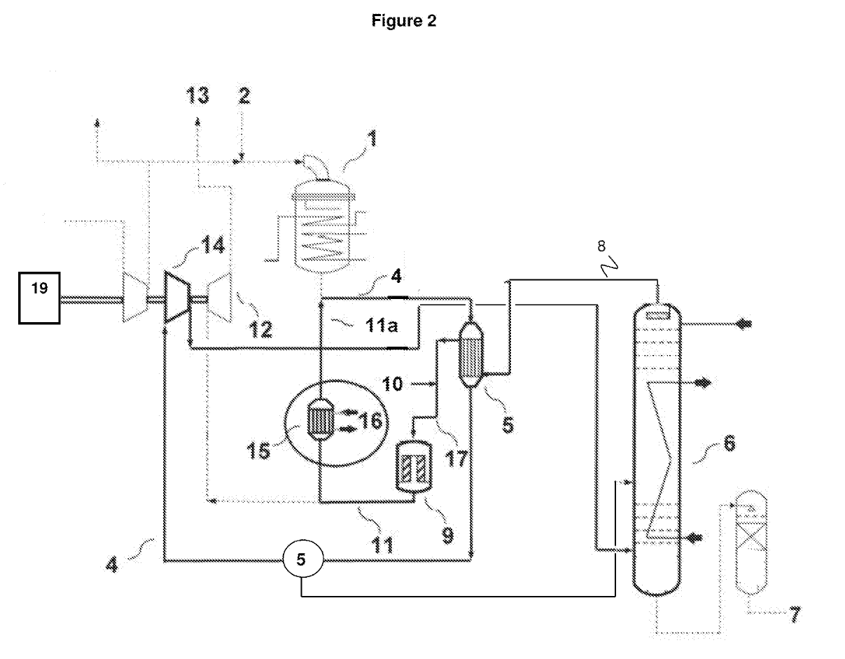

FIGS. 1 to 4 illustrate, schematically and by way of example, the process of the invention for preparing nitric acid, but are not to be interpreted as constituting a restriction. FIG. 1 shows a conventional process procedure, FIGS. 2 to 4 illustrate the process of the invention.

FIG. 1 shows a simplified flow diagram of a plant for preparing nitric acid in steady-state operation. In this, as is customary in nitric acid production, NOₓ nitrogen oxides (4) are produced, preferably in a burner (1) which is supplied with ammonia (2) and air (3). These NOₓ nitrogen oxides (4) are preferably conveyed via one or more heat exchangers (5) (which are not all shown), driven by the compressor (14), through the absorption column (6) in order to produce nitric acid (7). The residual gas containing the NOₓ nitrogen oxides (8) leaves the absorption column (6) and is preferably brought by means of various heat exchangers and/or liquefiers (5) to a temperature which preferably ensures optimal degradation of NOₓ nitrogen oxides in the residual gas purification plant (9). Here, introduction of ammonia (10) into the residual gas purification plant (9) is provided by way of example. The residual gas (11) which has been purified in this way goes, in steady-state operation, via the gas turbine (12) to the environment.

Normally, the pressure in the plant would gradually drop during intended shutdown of the plant or shutdown due to a malfunction. Furthermore, the residual gas purification plant (9) would inevitably shut down on reaching the limit temperature due to decreasing heat as depressurization progresses.

FIG. 2 depicts a connection variant according to the invention which shows how the process of effective degradation of NOₓ nitrogen oxides can be maintained during shutdown and/or start-up of the overall plant for preparing nitric acid. The flow diagram shows a plant for preparing nitric acid having an integrated additional heat exchanger which is located downstream of the residual gas purification plant and is preferably supplied with a heat-containing medium and with NOₓ nitrogen oxide-containing residual gas only during shutdown and/or start-up.

In order for an increased concentration of NOₓ nitrogen oxides in the residual gas not to be obtained at the exit from the offgas conduit (13), the purified residual gas (11) is preferably no longer released into the environment but is instead conveyed through the additional heat exchanger (15) which is then preferably supplied with high-pressure steam (16). This is preferably high-pressure steam which is preferably obtained at another place in the nitric acid production process. In order to emphasize that this apparatus is part of the process procedure according to the invention, the heat exchanger (15) according to the invention has been emphasized by means of an ellipse. The residual gas (11a) which has been heated in this way is subsequently preferably returned at a suitable place to the nitric acid production process. Here it is proposed that the heated residual gas (11a) be fed back into the pipe conveying the gas stream of the NOₓ nitrogen oxides (4) which are produced under normal conditions in the burner (1), so that the residual gases are finally conveyed via the conduit (17) back into the residual gas purification plant (9). This circulation, which is maintained by means of the compressor (14), is preferably carried out until the concentration of NOₓ nitrogen oxides in the residual gas has been reduced to such an extent that the access to the offgas conduit (13) is opened again and the residual gas can be released into the environment via the offgas conduit (13) without the NOₓ nitrogen oxides being visible at the outlet.

As an alternative to the compressor, the circulatory operation can also be maintained by means of a blower (not shown). This ensures that the circulation still functions even when the operation of the compressor suffers a malfunction.

On restarting the plant, the above-described circulation of the residual gas formed is preferably maintained until the normal operating pressure and the normal operating temperatures have been reached again, so that the supporting heat-transferring action of the additional heat exchanger (15) is no longer necessary in order to reduce the concentration of NOₓ nitrogen oxides in the residual gas to a minimum which is no longer visible. When this state has been attained, the heat exchanger (15) is preferably taken out of operation and the purified residual gases (11) are preferably once again released directly into the environment via the offgas conduit (13).

According to the process of the invention, the residual gas (11) flows, during shutdown and/or start-up of the plant for preparing nitric acid, firstly through the residual gas purification plant (9), is conveyed in a circuit and its temperature is regulated in the temperature regulating apparatus of the invention, which is preferably a heat exchanger (15). The residual gas is preferably brought to a temperature in the range from 300 to 550° C. The residual gas preferably flows through the temperature regulating apparatus only during shutdown and/or start-up of the plant for preparing nitric acid. The residual gas which has been temperature-regulated flows again through the residual gas purification plant (9) in which the concentration of NOₓ nitrogen oxides is preferably reduced. The residual gas preferably flows in the circuit through the temperature regulating apparatus and the residual gas purification plant (9). In another preferred embodiment, the residual gas flows in the circuit through the temperature regulating apparatus, the residual gas purification plant (9) and additionally through the plant for preparing nitric acid.

Parts of the plant which are not in operation in comparison with steady-state operation (FIG. 1) are shown in fine lines and broken lines.

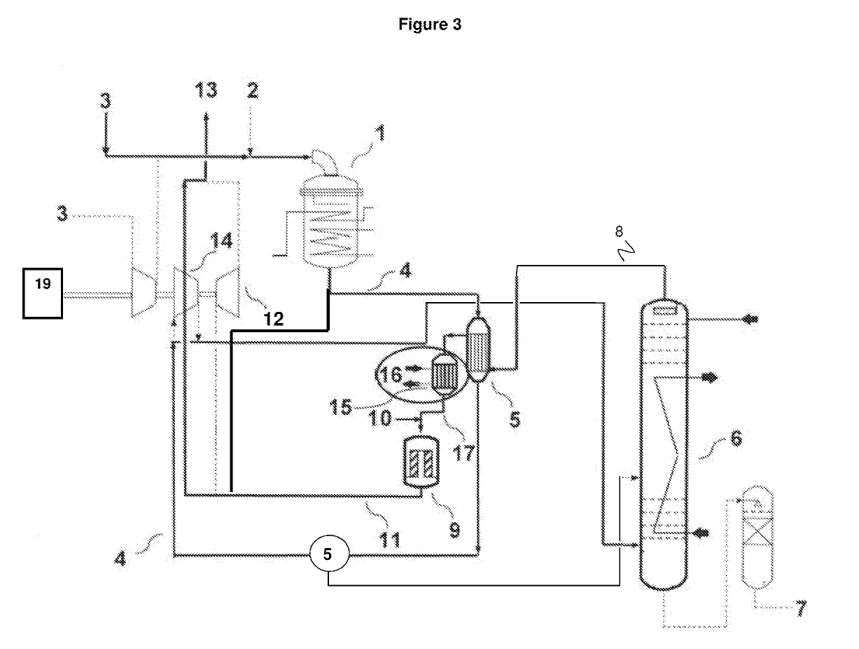

FIG. 3 shows a simplified flow diagram of a plant for preparing nitric acid with an integrated additional heat exchanger which is located upstream of the residual gas purification plant and is supplied with a heat-containing medium during shutdown and/or start-up. This heat exchanger is emphasized by means of an ellipse. Parts of the plant which are not in operation in comparison with steady-state operation (FIG. 1) are shown in fine lines and broken lines.

The plant for preparing nitric acid as is shown in FIG. 3 is operated in a similar way to that described in FIG. 2 during shutdown and/or start-up. In contrast to the plant illustrated there, residual gases (8) flow through the heat exchanger (15) according to the invention even during steady-state operation, but the heat exchanger (15) is preferably not supplied with a heat-containing medium (16) and therefore has no function during steady-state operation. Only when the plant is shut down and/or started up is the heat exchanger (15) supplied with a heat-containing medium and ensures that the residual gas which goes via the conduit (17) into the residual gas purification plant (9) has a temperature which is sufficiently high for degradation of the NOₓ nitrogen oxides to occur. In this process, the residual gas is preferably blown through the plant and the residual gas purification plant (9) by chimney action. Preference is given to no compressors being necessary to maintain this function. The chimney effect can optionally be reinforced by a blower (not shown). The purified residual gases finally leave via the offgas conduit (13).

When the plant is restarted, the operation of the heat exchanger (15) is preferably maintained until the normal operating pressure and the normal operating temperatures have been reached again, so that the supporting heat-transferring action of the additional heat exchanger (15) is no longer necessary to reduce the concentration of NOₓ nitrogen oxides in the residual gas to a minimum which is no longer visible. When this state has been attained, the heat exchanger (15) is preferably taken out of operation by stopping the introduction of the heat-containing medium (16). As an alternative, it is also possible to utilize the introduction of the heat-containing medium (16) even in steady-state operation of the plant, should this have an advantageous effect on the process.

According to the process of the invention, the temperature of the residual gas (8) is regulated in a temperature regulating apparatus, which is preferably a heat exchanger (15), during shutdown and/or start-up of the plant for preparing nitric acid. The temperature of the residual gas is preferably regulated before the residual gas flows through the residual gas purification plant (9). The residual gas is preferably brought to a temperature in the range from 300 to 550° C. The residual gas is subsequently treated in a residual gas purification plant (9). The regulation of the temperature of the residual gas is preferably used for decreasing the concentration of NOₓ nitrogen oxides in the residual gas in the residual gas purification plant (9).

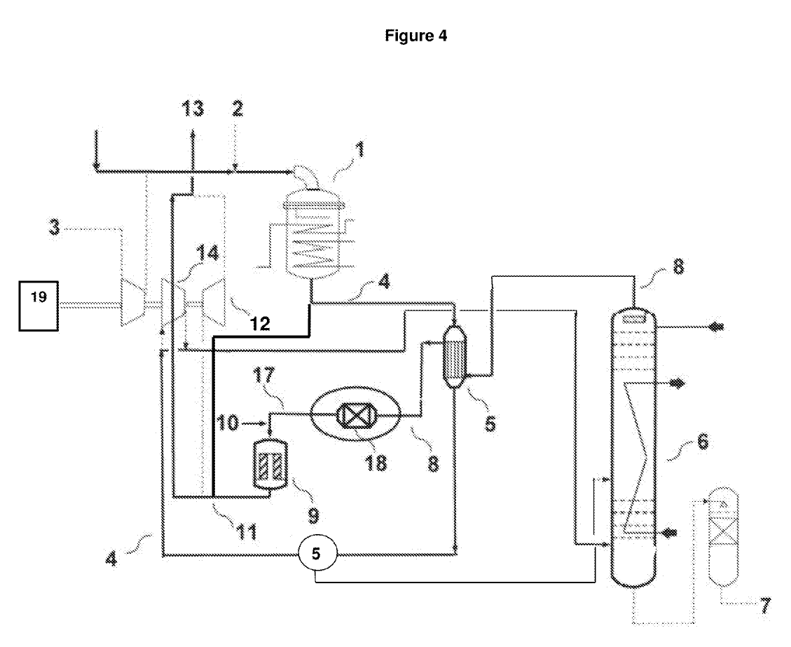

FIG. 4 shows a simplified flow diagram of a plant for preparing nitric acid having an integrated additional heat store which is located upstream of the residual gas purification plant. This heat store is emphasized by means of an ellipse. Parts of the plant which are not in operation in comparison with steady-state operation (FIG. 1) are shown in fine lines and broken lines.

The plant for preparing nitric acid as is shown in FIG. 4 is operated in a similar manner to that described in FIG. 2 and FIG. 3 during start-up and/or shutdown. However, a heat store (18) is used instead of the heat exchanger (15). Residual gas (8) flows through this during steady-state operation and over time the heat store stores part of the heat energy present in the residual gas. When the plant is shut down, only such an amount of energy that the residual gas which goes via the conduit (17) into the residual gas purification plant (9) has a temperature which is sufficiently high for degradation of the NOₓ nitrogen oxides to be ensured is present. In this process, the residual gas is preferably blown through the plant and the residual gas purification plant (9) by the chimney effect. Thus, no compressors are preferably required for maintaining this function. The chimney effect can optionally be reinforced by a blower (not shown). The purified residual gases finally leave via the offgas conduit (13).

If the plant is not down too long, so that sufficient heat energy is still present in the heat store (18) in order to bring the residual gas to a sufficiently high temperature in order to ensure satisfactory degradation of NOₓ nitrogen oxides in the residual gas purification plant (9), the same effect as during shutdown of the plant can be employed profitably in the restarting of the plant.

According to the process of the invention, the temperature of the residual gas (8) is regulated in a temperature regulating apparatus, which is preferably a heat store (18), during shutdown and/or start-up of the plant for preparing nitric acid. The temperature of the residual gas is preferably regulated before it flows through the residual gas purification plant (9). The residual gas is preferably brought to a temperature in the range from 300 to 550° C. The residual gas is subsequently treated in a residual gas purification plant (9). The regulation of the temperature of the residual gas is preferably used for decreasing the concentration of NOₓ nitrogen oxides in the residual gas in the residual gas purification plant (9).

### LIST OF REFERENCE NUMERALS

1 Burner
2 Ammonia
3 Air
4 NOₓ nitrogen oxides
5 Heat exchanger
6 Absorption column
7 Nitric acid
8 Residual gas containing NOₓ nitrogen oxides
9 Residual gas purification plant
10 Ammonia
11 Purified residual gas
12 Gas turbine
13 Offgas conduit
14 Compressor
15 Heat exchanger
16 High-pressure steam, heat-containing medium
17 Conduit
18 Heat store
19 Driving machine (e.g., electric motor or steam turbine)

1.-16. (canceled)

17. A process for decreasing the concentration of NOₓ nitrogen oxides in residual gas which is obtained during shutdown and/or start-up of a plant for preparing nitric acid, where the process comprises the following steps:
regulating temperature of the residual gas during shutdown and/or start-up of the plant for preparing nitric acid with a temperature regulating apparatus; and
treating the residual gas which has been temperature-regulated in said regulating step in a residual gas purification plant, where the temperature regulating apparatus is a heat exchanger or a heat store,
wherein the residual gas is at least partly conveyed in a circuit and in the circuit flows through the temperature regulating apparatus and the residual gas purification plant.

18. The process of claim 17, wherein the residual gas is conveyed through a compressor or a blower in the circuit.

19. The process of claim 17, wherein the process is carried out in one or both of a steady-state operation, which encompasses a part load, a full load, and an overload case, and also during shutdown and/or start-up of the plant for preparing nitric acid; and the residual gas flows through the temperature regulating apparatus both during steady-state operation, which encompasses the part load, full load and overload case, of the plant for preparing nitric acid and also during shutdown and/or start-up of the plant for preparing nitric acid.

20. The process of claim 19, wherein the residual gas flows through the temperature regulating apparatus only during shutdown and/or start-up of the plant for preparing nitric acid but not during steady-state operation, which encompasses the part load, full load and overload case, of the plant for preparing nitric acid.

21. The process of claim 17, wherein the temperature regulating apparatus is supplied with a medium which is suitable for releasing heat.

22. The process of claim 17, wherein the temperature regulating apparatus is configured to take up heat from a medium, storing it and releasing it again when required.

23. The process of claim 21, wherein the medium is discharged from the plant for preparing nitric acid and/or supplied from external sources.

24. The process of claim 21, wherein the medium comprises high-pressure steam at a pressure of >40 bar.

25. The process of claim 17, wherein the temperature regulating apparatus in said regulating step is electrically operated and/or comprises a burner.

26. The process of claim 17, wherein said regulating of the temperature of the residual gas is utilized for decreasing the concentration of NOₓ in the residual gas in the residual gas purification plant.

27. The process of claim 17, wherein the residual gas is brought to a temperature in the range from 200 to 550° C. in said regulating step.

28. The process of claim 17, wherein the residual gas is brought to a temperature in the range from 300 to 480° C. in said regulating step.

29. The process of claim 17, wherein the residual gas is brought to a temperature in the range from 260 to 380° C. in said regulating step.

30. An apparatus for decreasing the concentration of NOₓ nitrogen oxides in residual gas obtained during shutdown and/or start-up of a plant configured to prepare nitric acid, comprising the following components which are operatively connected to the plant:
a temperature regulating apparatus configured to regulate the temperature of the residual gas during shutdown and/or start-up of the plant for preparing nitric acid; and
a residual gas purification plant configured to decrease the concentration of NOₓ nitrogen oxides in the residual gas whose temperature has been regulated by the temperature regulating apparatus;
a gas bypass apparatus arranged downstream of the residual gas purification plant and configured to divert the residual gas into the temperature regulating apparatus; and
a conduit arranged downstream of the temperature regulating apparatus and configured to return the residual gas into a circuit with passage through the temperature regulating apparatus and the residual gas purification plant.

31. The apparatus of claim 30, wherein the temperature regulating apparatus is electrically operated and/or comprises a burner.

32. The apparatus of claim 30, wherein the temperature regulating apparatus is a heat exchanger or a heat store.

33. The apparatus of claim 30, comprising the following additional components which are operatively connected to the plant for preparing nitric acid:
a measuring apparatus configured to determine the concentration of NOₓ nitrogen oxides in the residual gas; and/or
a compressor and/or a blower.

34. The apparatus of claim 30, wherein the temperature regulating apparatus is:
a heat exchanger which is supplied with a medium suitable for releasing or taking up heat; or
a heat store configured to store heat from the residual gas during steady-state operation, which encompasses the part load, full load and overload case, of the plant for preparing nitric acid and which is configured to release heat to the residual gas during shutdown and/or start-up of the plant for preparing nitric acid.
